(19) United States
(12) Patent Application Publication
(10) Pub. No.: US 2005/0216374 A1
(43) Pub. Date: Sep. 29, 2005

(54) Smart giving program

(76) Inventor: Alan Fabian, Cockeysville, MD (US)

Correspondence Address: ROYAL W. CRAIG;A PROFESSIONAL CORPORATION, SUITE 153, 10 NORTH CALVERT STREET, BALTIMORE, MD, 21202, US

(21) Appl. No.: 11/074,304

(22) Filed: Mar. 7, 2005

Related U.S. Application Data
(60) Provisional application No. 60/550,939, filed on Mar. 5, 2004.

(51) Int. Cl. G06F 17/60

(52) U.S. Cl. 705/28

(57) ABSTRACT

Disclosed herein is a system and method that generally comprises a management/technology consulting service provider (SP) that is a registered charitable organization, a donor, and one or more non-profit/charitable donees/recipients. The method of the present invention allows a donor to contribute funds and receive a basket of hours that may be used at the donor's discretion to provide designated non-profit/charitable donees/recipients with management and/or technology consulting services. The process is facilitated by an agreement that is tailored to the needs and goals of the donor. The agreement details the hours that will be provided and the method by which the donor will designate, or direct, the use of the hours. Once the agreement is executed, the donor transfers the funds to the SP. The work performed by the SP for the designated donees/recipients may be clearly identified as having been provided by the respective donor. The SP then reports back to the donor on the results of the services provided.

### CROSS-REFERENCE TO RELATED APPLICATION(S)

The present application derives priority from U.S. Provisional Patent Application 60/550,939 filed Mar. 5, 2004.

### BACKGROUND OF THE INVENTION

1. Field of the Invention

The present invention relates to a method for a charitable intermediary (i.e. a service provider) to facilitate income tax deductible charitable contributions from donors to specified charities and non-profit organizations for consulting services. In return for the charitable contributions to the intermediary, the donor receives a commitment to provide a predetermined bundle of services to a charity of the donor's choice. In short, this method for intermediary donation/transaction management allows a donor to receive, in return for its contribution, a committed basket of hours that are used at the donor's discretion to provide consulting services to one or more designated charities.

2. Description of the Background

The philanthropic process is evolving because of changes in the attitudes and expectations of individual and corporate donors. Due, in part, to the unprecedented number of charities and nonprofit organizations (hereinafter referred to collectively as “charity” in the singular and “charities” in the plural) competing for limited dollars, there exists a desire for “donor-directed giving.” Donors are demanding, and receiving, the opportunity to oversee the way in which donated funds are being used by charities. Donors are demanding this in order to ensure that their donated funds, or services purchased with those funds, are actually being utilized by a charity for its exempt purposes.

The present inventor is not the first to address the need for a means for managing, or overseeing, non-profit/charitable donations/transactions. U.S. Pat. No. 6,581,041 to Canney, U.S. Pat. No. 5,909,794 to Molbak et al., U.S. Pat. No. 5,724,518 to Helbling, and U.S. Pat. No. 5,466,919 to Hovakimian, as well as U.S. Patent Application Nos. 2003/0177084 to Cassani et al., 2003/0110049 to Boys, 2002/0147621 to Smith, III, 2002/0120539 to Price, and 2002/0052756 to Lomangino disclose a variety of means for donation/transaction management.

U.S. Pat. No. 6,581,041 to Canney discloses a method of systematically linking investing with giving by designing a fee structure within an investment whereby a part of the fee is automatically transferred to a donor-selected account within a charitable community foundation. U.S. Pat. No. 5,909,794 to Molbak et al. discloses a donation transaction apparatus and method for facilitating donations to charitable organizations. The apparatus is configured to receive coins/cash, funds transfer authorizations, or credit charges, and then preferably dispenses a donation receipt to the donor which the donor may use to prepare or document income tax returns. Preferably, the donor is able to select among a plurality of charitable organizations to receive the donation. U.S. Pat. No. 5,724,518 to Helbling discloses a central office that correlates charitable contributions made at vending stations in food service establishments. U.S. Pat. No. 5,466,919 to Hovakimian discloses a method that enables a credit cardholder to make a donation to a cardholder-selected charity any time he makes a purchase using the credit card. The method may be described as being a bank expedited charity donation approach for credit/charge cardholders.

U.S. Patent Application No. 2003/0177084 to Cassani et al. discloses an investment fund in which a portion of the assessed investment fund fees and/or investment fund service providers' fees are designated for donation to charitable causes as directed by each of the investment fund's shareholders. Donation amounts are then tracked and paid to charities on a periodic basis according to the designations on the records of the investment fund. U.S. Patent Application No. 2003/0110049 to Boys discloses a system for direct donation utilizing an Internet-connected server accessible by potential donors using an Internet browser and a data store accessible to the server, and storing information about potential recipients that are pre-qualified for donations. A software suite executing on the server has at least a first facility enabling a potential donor to view specific information about qualified recipients of donations, and a second facility enabling the same donor to select a recipient and make a direct donation to the selected recipient.

U.S. Patent Application No. 2002/0147621 to Smith, III discloses an automated method for allowing one or more donors to make periodic donations to one or more organizations with a single payment for each period, and to communicate requests for action to said organizations. The method allows donors to select one or more organizations to donate to, and to specify a specific amount to donate to each.

U.S. Patent Application No. 2002/0120539 to Price discloses methods and systems for distributing charitable donations at the point of sale to qualified donees in the manner specified by a donor. A charitable donation is distributed in the form of purchase credits toward the purchase of the verified products or services in accordance with at least one donor subscription agreement.

U.S. Patent Application No. 2002/0052756 to Lomangino discloses a system in which donor members transfer items to recipient members without receiving economic remuneration from the recipient members.

In summary of all the foregoing, (i) some form of central database for correlating, coordinating, and/or tabulating charitable contributions is disclosed in the Helbling '518 patent (i.e. a central office) and the Boys patent application (i.e. an Internet-connected server), (ii) donor-directed giving is included in the Canney, Molbak et al., and Hovakimian patents and the Cassani et al., Smith, III, Lomangino, and Boys patent applications, (iii) donor-specified actions are found in the Smith, III patent application, and (iv) a subscription agreement allowing a donor to dictate the manner in which a donation will be used to purchase verified “services” is disclosed in the Price patent application. However, none of the above-discussed prior art references disclose a system/method that (i) includes a management/technology consulting service provider (SP) as a registered charitable organization, (ii) negotiates and executes a formal donation agreement, prior to the transfer of a directed contribution from the donor directly to the SP, (iii) specifies the type and amount of consulting services that are to be provided to one or more donees or (iv) requires the SP to make a full report back to the donor on the results of those consulting services. In today's environment of increasing public scrutiny and government regulations, the nonprofit community needs to work in closer partnership with their investors to ensure that dollars are spent wisely and the maximum return on investment occurs for both those who receive services and those who invest in those services. Nonprofits need information systems and strategic plans that provide for greater accountability, outcome measurement and increased operational efficiency, and yet today's social investors insist on low overhead in the nonprofits they support, which in turn may preclude the nonprofits ability to invest in the management and technology systems that are essential to delivering effective services. Therefore, there remains a need for a system and method that provides a substantial degree of utility in delivering donor-specified management and technology consulting services to one or more non-profit/charitable donees/recipients. A more proficient program will include the general steps of (i) establishing a consulting services provider (i.e. a management/technology consulting SP) as a registered charitable organization, (ii) negotiating and executing a formal donation agreement between the SP and a donor prior to the donation of consulting services to a charity, (iii) identifying the originating donor of the consulting services to the charity, (iv) providing the charity with the pre-defined/pre-arranged consulting services, and (v) providing a report to the donor regarding the results of the services provided by SP to the charity.

### SUMMARY OF THE INVENTION

The primary object of the present invention is to provide an improved system and method for intermediary donation/transaction management. Specifically, to provide such a system that allows a donor to receive, in return for its income tax-deductible donation to a non-profit intermediary, a committed basket of hours that are used at the donor's direction to provide the intermediary SP's consulting services to a designated non-profit/charitable donees/recipients. The non-profit intermediary involvement in facilitating the program affords the donee all tax advantages, and further allows donor oversight and direction over the use of donated funds. This bridges the gap by incentivizing investments in non-profit information technology and strategic plans that provide for greater accountability, outcome measurement and increased operational efficiency.

It is another object to multiply and increases the lifespan of a donor's gift and to provide greater accountability for it.

It is another object to provide donors with measurable outcomes that demonstrate concrete results.

It is still another object to save nonprofit organizations from devoting resources to identifying, hiring and managing an outside consultant to provide crucial management and technology services.

It is a more specific object to provide an improved system and method for use in managing non-profit/charitable donations that begins with the establishment of a service provider (i.e. a management/technology consulting service provider) as a registered charitable organization and, once established, to rely on the service provider to facilitate the negotiation of a formal Memorandum of Understanding between the service provider and a donor prior to the charitable gift, which Memorandum of Understanding is then formally executed. The Memorandum of Understanding clearly identifies the donor and provides attribution for the gifted management/technology consulting services to the one or more recipient charities. It also pre-defines specific management/technology consulting services to be provided to the charities.

It is another object to rely on the service provider to deliver the agreed-upon consulting services per the memorandum of Understanding and account back to the donor on the results of the services delivered.

These and other objectives are accomplished by a method that begins with the formation of an consulting service intermediary (i.e. a management/technology consulting service provider) (SP) registered as a charitable organization, a donor who desires to donate consulting services to one or more non-profit organizations, and one or more charities in need of and willing to accept a donation in the form of consulting services. The method of the present invention allows an individual or corporate donor to make tax-favored contributions of funds to the intermediary service provider and receive a basket of service hours that may be used at the donor's direction to provide designated charities with consulting services (i.e. management and/or technology consulting services). The process is facilitated by a negotiated agreement (Memorandum of Understanding) between a prospective donor and the service provider on behalf of a designated third party beneficiary, a non-profit donee, to allow the donee to obtain a package of consulting services (i.e. basket of hours) tailored as directed by the donor to the needs of the donee charity. The Memorandum of Understanding details the hours that will be provided and the method by which the donor will designate, or direct, the use of those hours. Once the agreement is executed, the donor transfers finds to the service provider for which it receives an immediate charitable income tax deduction. The work is then performed by the service provider for the designated charities, and the work is branded as having been provided by the respective donor. The service provider then reports back to the donor on the results of the services provided.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a schematic showing the relationship between an intermediary management/technology consulting service provider 10 according to a preferred embodiment of the present invention, a donor 20, and non-profit/charitable donees/recipients 30.

FIG. 2 is a flowchart of the donor management method/process 100, for non-profit/charitable contributions, according to a preferred embodiment of the present invention.

FIG. 3 (parts 3A & 3B) comprises an exemplary Memorandum of Understanding to be used at step 120 between the donor 20 and the SP 10.

### DETAILED DESCRIPTION OF THE PREFERRED EMBODIMENTS

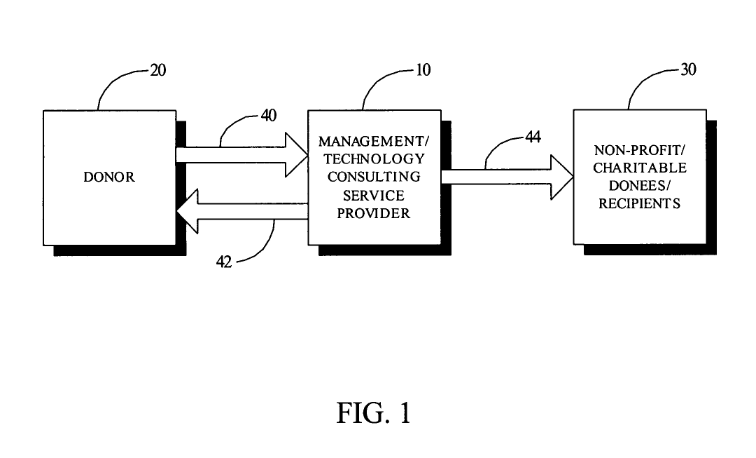

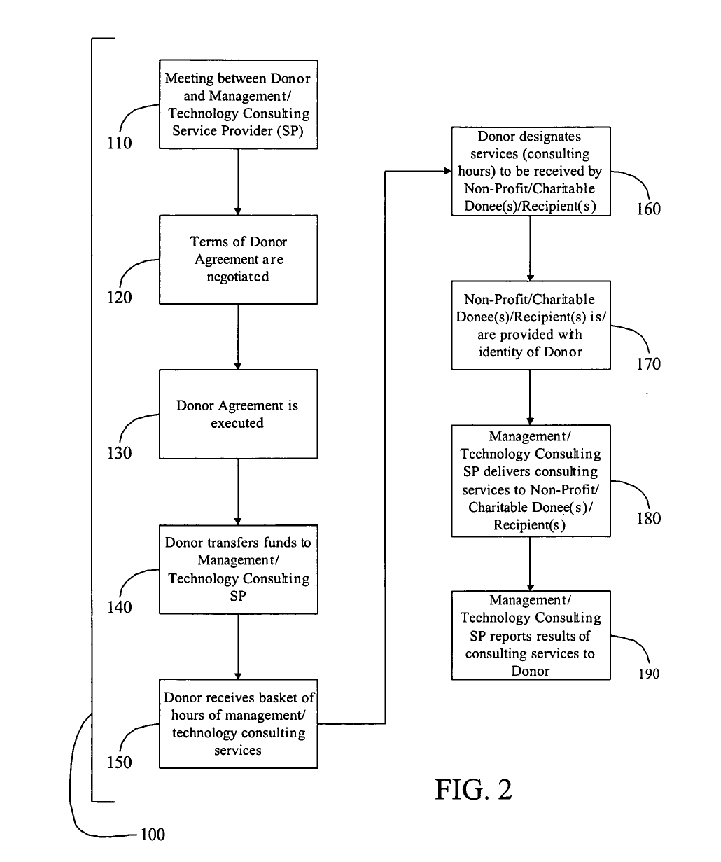

FIG. 1 is a schematic showing the relationship between a management/technology consulting service provider (SP) 10 according to a preferred embodiment of the present invention, a donor 20, and one or more non-profit/charitable donees/recipients 30. The schematic essentially indicates the flow of funds, information, and/or services among the three entities 10, 20, 30. Funds and information flow from the donor 20 to the service provider 10 along arrow 40. Information flows from the SP 10 back to the donor 20 along arrow 42. Lastly, consulting services and information regarding the donation of those consulting services flow from the SP 10 to the donee(s)/recipient(s) 30 (See arrow 44). The flow of finds, information, and/or services will be discussed in greater detail below with respect to the donor management method/process 100 of FIG. 2.

FIG. 2 is a more detailed flowchart of the donor management method/process 100 for non-profit/charitable contributions, according to the preferred embodiment of the present invention.

Initially, the management/technology consulting service provider (SP) 20 is established and must be registered with the Internal Revenue Service as a charitable organization. Once this is accomplished, the method/process 100 begins, at step 110, with an information transaction (preferably a meeting, phone conference, etc.) between the SP 10 (see FIG. 1) and a prospective donor 20 (see again FIG. 1).

The purpose of the transaction is, as shown in step 120, to negotiate the terms of a donor agreement or “Memorandum of Understanding.” In order to negotiate the agreement (step 120) information must flow between the SP 10 and the donor 20 along arrows 40 and 42 of FIG. 1. The terms of the agreement 200 must include the amount of money the donor 20 is willing to contribute and the number of hours of the SP's consulting services that such a donation will procure. The agreement 200 should also identify the donor's intended donee(s)/recipient(s) 30 and the manner by which the donor 20 will instruct the SP 10 to deliver/provide (i.e. when, to whom) the management/technology consulting services. Once the terms have been finalized, they are reduced to a written agreement that is executed by the parties (SP and Donor) 10, 20 at step 130.

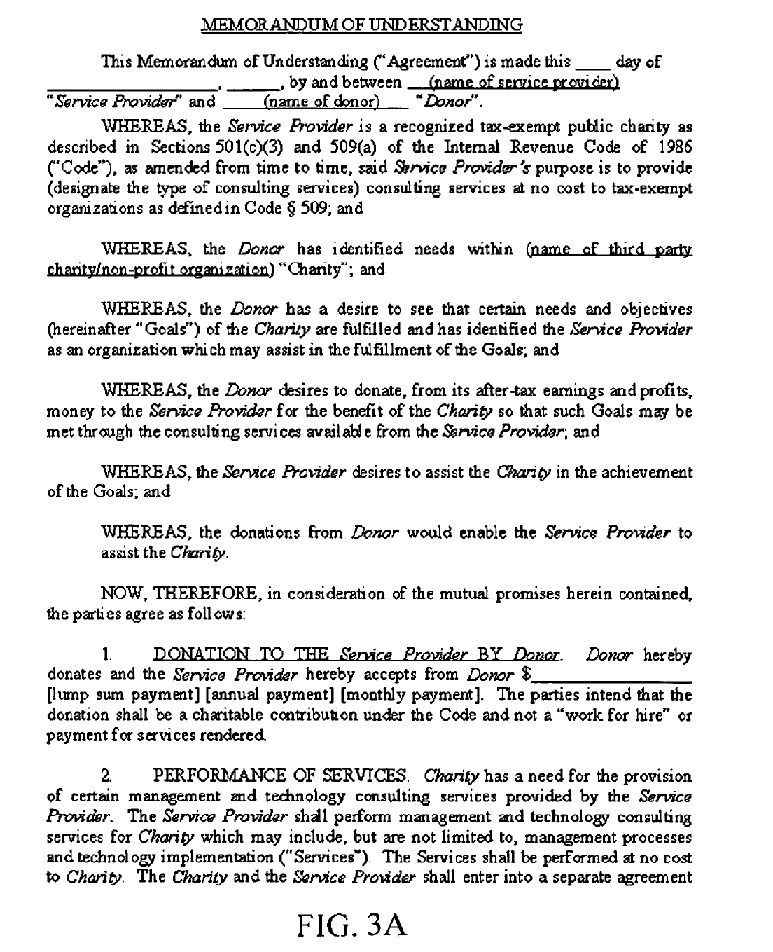

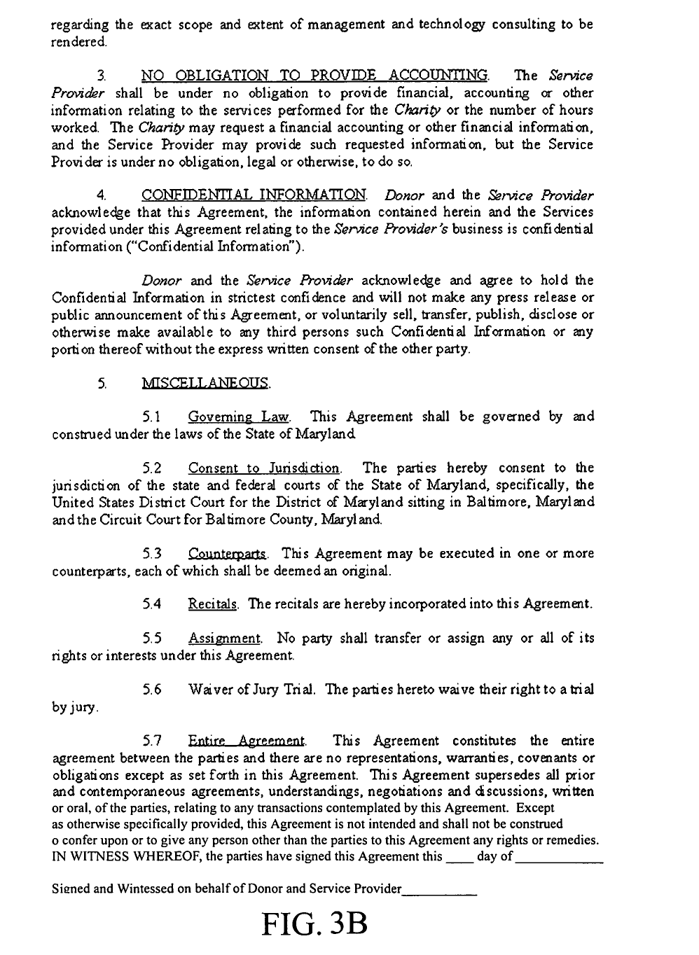

FIG. 3 (parts 3A & 3B) comprises an exemplary Memorandum of Understanding to be used at step 120 between the donor 20 and the SP 10. The Memorandum of Understanding reflects all material terms to the agreement.

Again referring to FIG. 2, in accordance with the agreement (at step 140) the donor 20 transfers the appropriate funds to the SP 10 (see arrow 40 of FIG. 1) and receives in return, at step 150, a commitment from the SP 10 to provide a predefined basket of hours of management/technology consulting services to one or more specified non-profits 30. The number of consulting hours available/remaining in a donor's “basket” are typically tracked in an accounting system, computerized or otherwise, maintained by the SP 10.

A web-based tracking tool may be used to allow the consultants to report on the number of hours provided to each recipient and thus reporting can be accessed by the donor through a virtual private network when consultants are out of the office.

At step 160, when appropriate and, again, in accordance with the terms of the agreement, the donor 20 designates the services and number of hours of service that are to be delivered to one or more of the non-profit/charitable donee(s)/recipient(s) 30 (see FIG. 1) by the SP 10. The range of consulting services provided to the clients include, but are not limited to, Strategy, Management, Analytics, Reporting and Technology consulting.

The information designating the services and intended donee(s)/recipient(s) 30, flowing from the donor 20 to the SP 10, is represented by arrow 40 in FIG. 1.

Prior to the delivery of the services from the SP 10 to the donee(s)/recipient(s) 30, the donee(s)/recipient(s) 30 is/are provided with information including the identity of the donor 20 at step 170 (See also flow of information along arrow 44 of FIG. 1).

At step 180, the SP 10 provides the donated consulting services (i.e. management and/or technology consulting services) to the non-profit/charitable donee(s)/recipient(s) 30. At steps 170 and 180, the transfer/delivery of the donor's identity and the consulting services from the SP 10 to the donee(s)/recipient(s) 30 are represented by arrow 44 in FIG. 1.

Finally, at step 190 of the method/process 100, the SP 10 submits a report of the results of the consulting services to the donor 20 (i.e. how the non-profit/charitable donee(s)/recipient(s) 30 benefitted from the receipt of the management and/or technology consulting services). This flow of information is represented by arrow 42 of FIG. 1.

In today's philanthropic environment, the non-profit/charitable community needs to operate in partnership with their donors to insure that donated funds are spent wisely. Donor's are mandating the maximum possible return on investment for their charitable gifts. Charities need systems and strategic plans that provide for greater accountability, outcome measurement, and increased operational efficiency.

The present invention represents an innovative way to provide contemporary donors/philanthropists with an opportunity to direct tailored management and technology consulting services to achieve their long-term philanthropic goals and improve the overall health of the donee charitable organizations. Individual, corporate, and foundational donors that support non-profit/charitable organizations can maximize their philanthropic investment and assist in the creation of self-sustaining organizations through the utilization of the present invention. The present invention helps donated funds to go farther and do more, thereby strengthening a donor's investment in a charity.

Donors today insist on low overhead costs in the charities they support. However, overhead expenditures do not allow charities to invest in the management and technology systems that are essential to effectively delivering charitable services. The present invention provides a novel means for supporting charitable organizations, and allows charities to increase their overall impact in the communities they serve.

The method and process of the present invention provides a substantial degree of utility in delivering management and/or technology consulting services to non-profit/charitable organizations in an efficient and cost effective manner. The primary benefits of the present invention include:

1. An increase in the effective value of donations when used for the direct purchase of consulting services from a non-profit management/technology consulting service provider.

2. Greater accountability, provided to the donor, as to the nature and results of the consulting services purchased with a donation.

3. Measurable outcomes demonstrating concrete results of the management/technology consulting services delivered to charity.

4. Delivery of consulting solutions to charitable organizations at no cost, as opposed to the use of budgeted dollars to pay for costly for-profit management or technology consulting firms.

5. Charitable donee(s) do not have to devote resources to identifying, hiring, and managing a third party consulting firm to provide crucial management and technology consultation services.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

1. A method of facilitating the provision of management or technology consulting services to non-profit/charitable organizations, comprising:
a first step of establishing a consulting service provider as a registered charitable organization;
a second step of negotiating and executing a formal donation agreement between the consulting service provider and a donor for the provision of pre-defined consulting services to a designated charity;
a third step of said consulting service provider providing the designated charity with the pre-defined consulting services; and
a fifth step of said consulting service provider providing a report to the donor accounting for results of the services provided to the charity.

2. A method of facilitating the provision of management or technology consulting services to non-profit/charitable organizations according to claim 1, wherein said management or technology consulting services include any from a group consisting of strategy consulting, management consulting, analytics, reporting, and technology consulting.

3. A method of facilitating the provision of management or technology consulting services to non-profit/charitable organizations according to claim 1, wherein said second step further comprises a substep of said donor transferring funding directly to the consulting service provider after said execution of a formal donation agreement.

4. A method of facilitating the provision of management or technology consulting services to non-profit/charitable organizations according to claim 1, wherein said second step further comprises a first sub-step of said donor transferring funding directly to the consulting service provider after said execution of the formal donation agreement.

5. A method of facilitating the provision of management or technology consulting services to non-profit/charitable organizations according to claim 4, wherein said second step further comprises a second sub-step of said consulting service provider providing said donor with a written commitment to provide a predefined number of hours of consulting services to said charity after said execution of the formal donation agreement.

6. A method of facilitating the provision of management or technology consulting services to non-profit/charitable organizations according to claim 5, wherein said third step further comprises said consulting service provider providing said predefined number of hours of consulting services to said charity after said execution of the formal donation agreement.

7. A method of facilitating the provision of management or technology consulting services to non-profit/charitable organizations according to claim 6, wherein said fifth step of providing a report to the donor further comprises tracking in an accounting system a number of consulting hours remaining to be provided to the charity by said consulting service provider.

8. A method of facilitating the provision of management or technology consulting services to non-profit/charitable organizations according to claim 1, wherein said third step further comprises said consulting service provider branding the consulting services provided to said charity with an identity of said donor.

9. A method of facilitating the provision of management or technology consulting services to non-profit/charitable organizations according to claim 7, wherein said fifth step of providing a report to the donor further comprises a report of how the charity benefited from the receipt of said consulting services.

10. A method of facilitating the provision of management and/or technology consulting services to non-profit/charitable organizations, comprising the steps of:
conducting a meeting between a non-profit management/technology consulting service provider and a donor;
negotiating terms for a donor agreement between said consulting service provider and said donor;
reducing said terms of said donor agreement to a written instrument;
executing said written donor agreement between said consulting service provider and said donor;
transferring funds to said consulting service provider from said donor;
creating a donor account containing a basket of hours of management/technology consulting services;
designating a quantity of management and/or technology consulting hours to be delivered by said consulting service provider to one or more non-profit/charitable donees/recipients;
identifying said donor to said one or more non-profit/charitable donees/recipients;
delivering said designated quantity of management and/or technology consulting hours to said one or more non-profit/charitable donees/recipients by said consulting service provider;
tracking the hours of management/technology consulting services remaining in said basket using an accounting system maintained by said consulting service provider; and
reporting all results of said management/technology consulting services to said donor.

11. The method of facilitating the provision of management and/or technology consulting services to non-profit/charitable organizations according to claim 10, wherein said step of negotiating terms for a donor agreement further comprises negotiating a predefined amount of money the donor is willing to contribute, and a predefined number of hours of the service provider is willing to provide for said predefined amount of money.

12. The method of facilitating the provision of management and/or technology consulting services to non-profit/charitable organizations according to claim 11, wherein said step of negotiating terms for a donor agreement further comprises identifying the donor's intended charity recipient of said consulting services and a predefined manner by which consulting service provider is to deliver said services.

13. The method of facilitating the provision of management and/or technology consulting services to non-profit/charitable organizations according to claim 12, wherein said predefined manner by which consulting service provider is to deliver said services includes when said services will be provided and by whom.
